(19) United States
(12) Patent Application Publication
(10) Pub. No.: US 2019/0047434 A1
(43) Pub. Date: Feb. 14, 2019

(54) EFFICIENT USE OF RESOURCES WHILE/AFTER CHARGING A VEHICLE

(71) Applicant: Faraday&Future Inc., Gardena, CA (US)

(72) Inventors: Sangmin Oh, Santa Clara, CA (US); Carlos John Rosario, San Jose, CA (US); Kai Ni, Sammamish, WA (US)

(21) Appl. No.: 15/720,154

(22) Filed: Sep. 29, 2017

Related U.S. Application Data
(60) Provisional application No. 62/402,980, filed on Sep. 30, 2016.

(51) Int. Cl. B60L 11/18; G06Q 50/06

(52) U.S. Cl. CPC B60L 11/1844; G06Q 50/06; B60L 11/1842; B60L 11/1887

(57) ABSTRACT

A method for operating an electric vehicle (EV) includes receiving a request for access to resources, determining whether an energy storage device that provides power to the EV is electrically coupled to a charging station, determining a charge status of the energy storage device, and granting access to the resources based on the determination of whether the EV is coupled to the charging station, and the charge status of the energy storage device. The method can further determining whether a user making the request is one of a set of approved users of the EV, and determining whether one of the set of approved users is currently using the EV. Granting access to the resources may be based on when the user is not one of a set of approved users of the EV, and one of the set of approved users is not currently using the EV.

### CROSS-REFERENCE TO RELATED APPLICATIONS

This application claims the benefit of U.S. Provisional Application No. 62/402,980, filed Sep. 30, 2016, the entirety of which is hereby incorporated by reference.

### BACKGROUND

Electric vehicles (EVs) are becoming more and more popular with some EV sales estimates in the United States alone approaching 500,000 vehicles sold since 2008. Many EV owners charge their vehicles at home. However, public charging stations are becoming more commonplace and can be found at places of employment, shopping malls, college campuses, stores, restaurants, and the like. Public charging stations can be convenient and, in some cases, may be necessary to enable long distance travel over distances greater than a single-charge range of the EV.

As EVs become more commonplace, charging station availability may become more scarce as public infrastructure slowly ramps up charging resources across the country. To make matters worse, some EV owners may leave their EV connected to a charging station for hours, even after the EV energy storage device (e.g., battery) reaches a maximum charge. This can unnecessarily limit charging station usage and prevent others from charging their EVs during these periods of non-use (e.g., no charging activity). Better ways of managing charging station usage are needed.

### BRIEF SUMMARY

In certain embodiments, a computer-implemented method for operating an electric vehicle (EV) includes receiving a request for access to resources, determining whether an energy storage device that provides power to the EV is electrically coupled to a charging station, determining a charge status of the energy storage device, and granting access to the resources based on the determination of whether the EV is coupled to the charging station, and the determination of the charge status of the energy storage device. The method can further include determining that the request is for a user to have the access to the resources, determining whether the user is one of a set of approved users of the EV, and determining whether one of the set of approved users is currently using the EV, where granting access to the resources is further based on the determination that the user is not one of a set of approved users of the EV, and the determination that one of the set of approved users is not currently using the EV.

In some embodiments, the method can further include determining when one of the set of approved users is scheduled to be using the EV, calculating an expected charge status of the energy storage device after the user is scheduled to finish using the resources, and calculating an expected completion time to charge the energy storage device to a threshold value after the user is finished using the resources based on the expected charge status of the energy storage device after the user is finished using the resources, and an expected charging rate of the energy storage device on the charging station. In some cases, granting the user access to the resources can be further based on whether an expected completion time to charge the energy storage device to a threshold value occurs before the one of the set of approved users is scheduled to be using the EV.

In some implementations, the resources of the method can include at least one of EV processor access, EV sensor access, EV automotive control, or EV coupling control with the charging station, among other resources. EV processor access can include performing computational tasks using one or more EV processors. EV sensor access can include controlling and accessing at least one of an image sensor or corresponding image sensor data of the image sensor, an audio sensor or corresponding audio sensor data of the audio sensor, or an environmental sensor or corresponding environmental sensor data of the environmental sensor. In certain embodiments, the EV sensor access can include controlling one or more of the EV sensors to generate at least one of high-definition (HD) mapping data or local weather data.

In further embodiments, granting user access to EV automotive control may include providing full driving privileges of the EV to the user. In some cases, granting user access to EV automotive control may include providing limited driving privileges of the EV to the user including moving the EV from the charging station to a different approved location. EV coupling control can include granting user access to disconnect the energy storage device from the charging station. In some embodiments, the method can further include notifying an owner of the EV in response to granting access to the resources.

In certain embodiments, a computer-implemented method for operating an electric vehicle (EV) includes receiving a request for a task unrelated to the EV, determining whether an energy storage device that provides power to the EV is electrically coupled to a charging station, determining a charge status of the energy storage device, and fulfilling the request for the task by accessing computer or sensor resources on board the EV based on the determination of whether the EV is coupled to the charging station, and the determination of the charging status of the energy storage device. In some cases, fulfilling the request for the task can be further based on determining whether one of a set of approved users of the EV is currently using the EV.

In some embodiments, the computer resources on board the EV may include one or more EV processors. The sensor resources on board the EV may include at least one of an image sensor or corresponding image sensor data, an audio sensor or corresponding audio sensor data, or an environmental sensor or corresponding environmental sensor data. The method can further include notifying an owner of the EV in response to the accessing computer or sensor resources on board the EV.

In certain embodiments, a system includes one or more processors and one or more non-transitory computer-readable storage mediums containing instructions configured to cause the one or more processors to perform operations including receiving a request for access to resources, determining whether an energy storage device that provides power to the EV is electrically coupled to a charging station, determining a charge status of the energy storage device, and granting access to the resources based on the determination of whether the EV is coupled to the charging station, and the determination of the charge status of the energy storage device.

In some embodiments, the instructions can be further configured to cause the one or more processors to perform operations including determining that the request is for a user to have the access to the resources, determining whether the user is one of a set of approved users of the EV, and determining whether one of the set of approved users is currently using the EV. Granting access to the resources can be further based on the determination that the user is not one of a set of approved users of the EV, and the determination that one of the set of approved users is not currently using the EV.

In further embodiments, the instructions can be further configured to cause the one or more processors to perform operations including determining when one of the set of approved users is scheduled to be using the EV, calculating an expected charge status of the energy storage device after the user is scheduled to finish using the resources, and calculating an expected completion time to charge the energy storage device to a threshold value after the user is finished using the resources based on the expected charge status of the energy storage device after the user is finished using the resources, and an expected charging rate of the energy storage device on the charging station. Granting the user access to the resources may be further based on whether an expected completion time to charge the energy storage device to a threshold value occurs before the one of the set of approved users is scheduled to be using the EV. In certain embodiments, the resources can include at least one of EV processor access, EV sensor access, EV automotive control, or EV coupling control with the charging station.

In some cases, EV sensor access may include controlling and accessing at least one of an image sensor or corresponding image sensor data, an audio sensor or corresponding audio sensor data, or an environmental sensor or corresponding environmental sensor data. EV coupling control may include granting access to disconnect the energy storage device from the charging station. In certain implementations, the instructions are further configured to cause the one or more processors to perform operations including notifying an owner of the EV in response to granting access to the resources.

### BRIEF DESCRIPTION OF THE DRAWINGS

The detailed description is set forth with reference to the accompanying figures.

FIG. 1 shows aspects of providing a user access to EV resources, according to certain embodiments.

FIG. 2 shows aspects of pooling EV resources across a fleet of vehicles, according to certain embodiments.

FIG. 3 shows aspects of using EV sensor resources, according to certain embodiments.

FIG. 4 shows aspects of coordinating usage of EV resources, according to certain embodiments.

FIGS. 5A and 5B show aspects of moving an EV after reaching a threshold charge, according to certain embodiments.

FIG. 6 is a simplified flow chart showing a method of providing access to resources based on a charging status of an EV, according to certain embodiments.

FIG. 7 shows a system for providing access to resources based on a charging status of an EV, according to certain embodiments.

### DETAILED DESCRIPTION

Aspects of the present disclosure relate generally to vehicular systems, and in particular to providing access to resources on an EV, according to certain embodiments.

In the following description, various embodiments of providing access to resources based on a charging status of an EV will be described. For purposes of explanation, specific configurations and details are set forth in order to provide a thorough understanding of the embodiments. However, it will be apparent to one skilled in the art that certain embodiments may be practiced without every disclosed detail. Furthermore, well-known features may be omitted or simplified in order not to obscure the embodiments described herein.

As EVs become more commonplace, charging station availability may become more scarce as public infrastructure slowly ramps up charging resources across the country. Furthermore, EV owners may leave their EV connected to a charging station for hours, even after the EV energy storage device (e.g., battery) reaches a maximum charge. This can unnecessarily limit charging station usage and prevent others from charging their EVs during these periods of non-use (e.g., no charging activity).

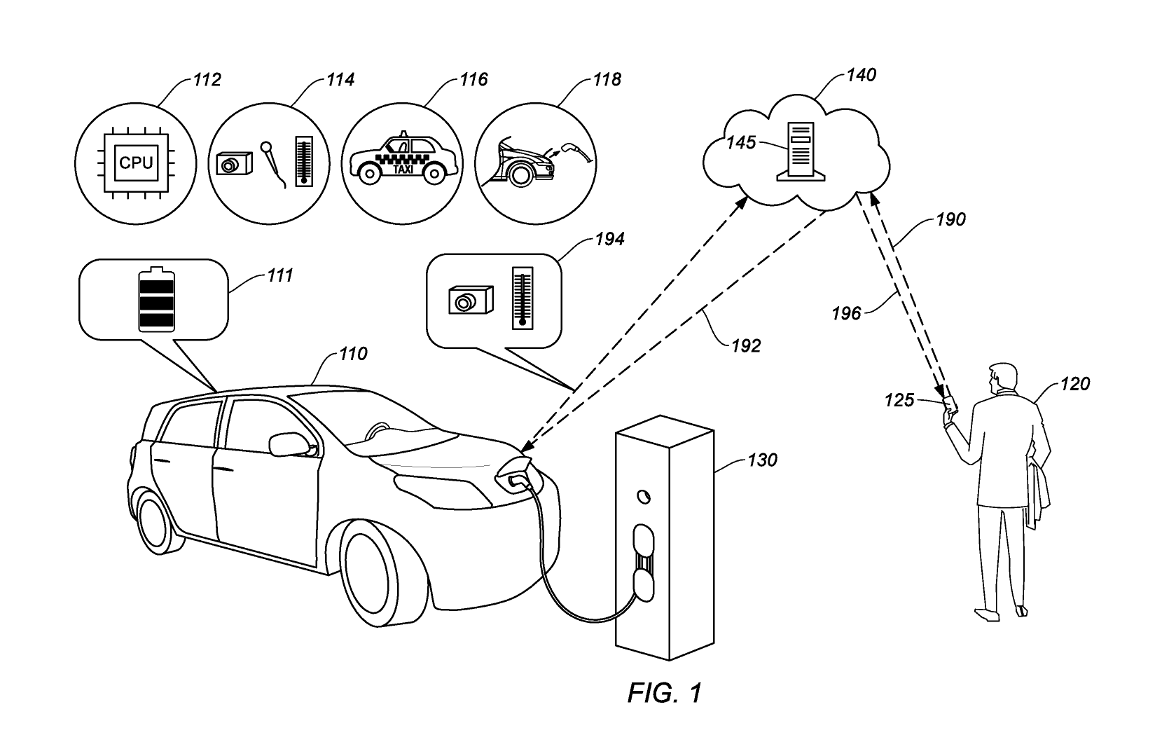

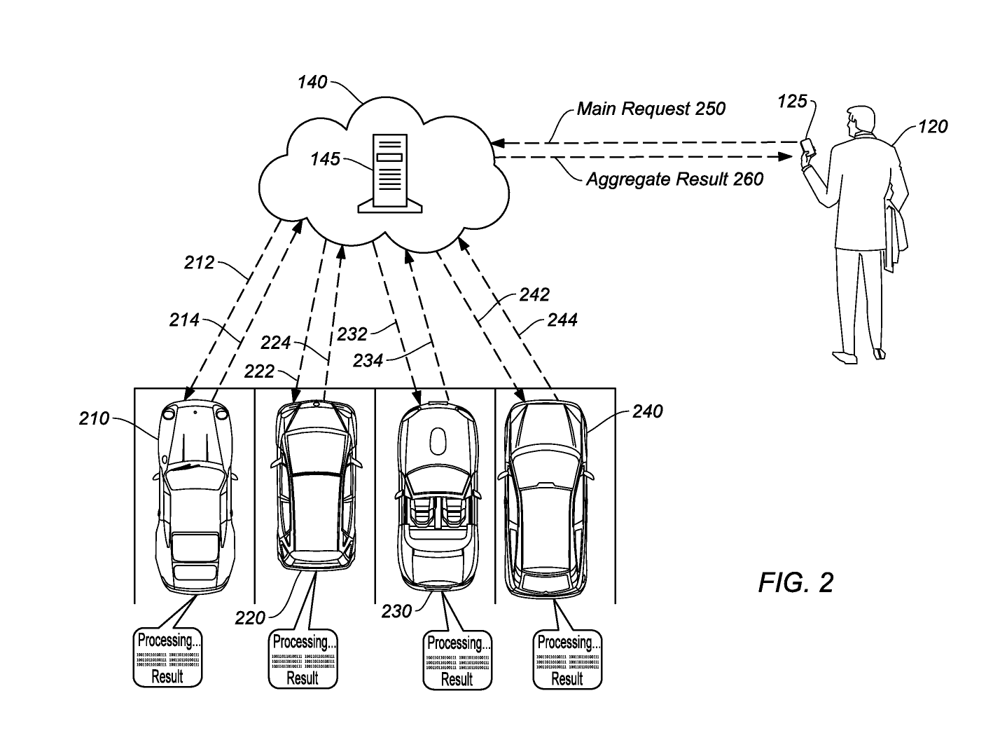

Certain aspects of the present invention make efficient use of EV resources during these periods of non-use. In some embodiments, certain resources of the EV may be used while the EV is coupled to a charging station and charged at least to a threshold value. For example, EV processor(s) and sensors (e.g., audio, image, temperature, etc.) may be utilized, as shown in FIG. 1. The EV sensors can be used to, e.g., survey an area to generate mapping data and/or weather data. In some embodiments, certain tasks can involve resources from multiple vehicles that collectively contribute to a resultant solution, as shown in FIG. 2. The nature of the task can be related or unrelated to a particular EV itself. For example, a computational task may be formulated in a server in the cloud, and the server may select resources (e.g., EV processors) from various EVs to perform the computational task. In such cases, any particular EV would not necessarily be tied to the task as the EV's resources could be interchanged with another available set of resources from a different EV. One of ordinary skill in the art would understand the many variations, modifications, and alternative embodiments thereof.

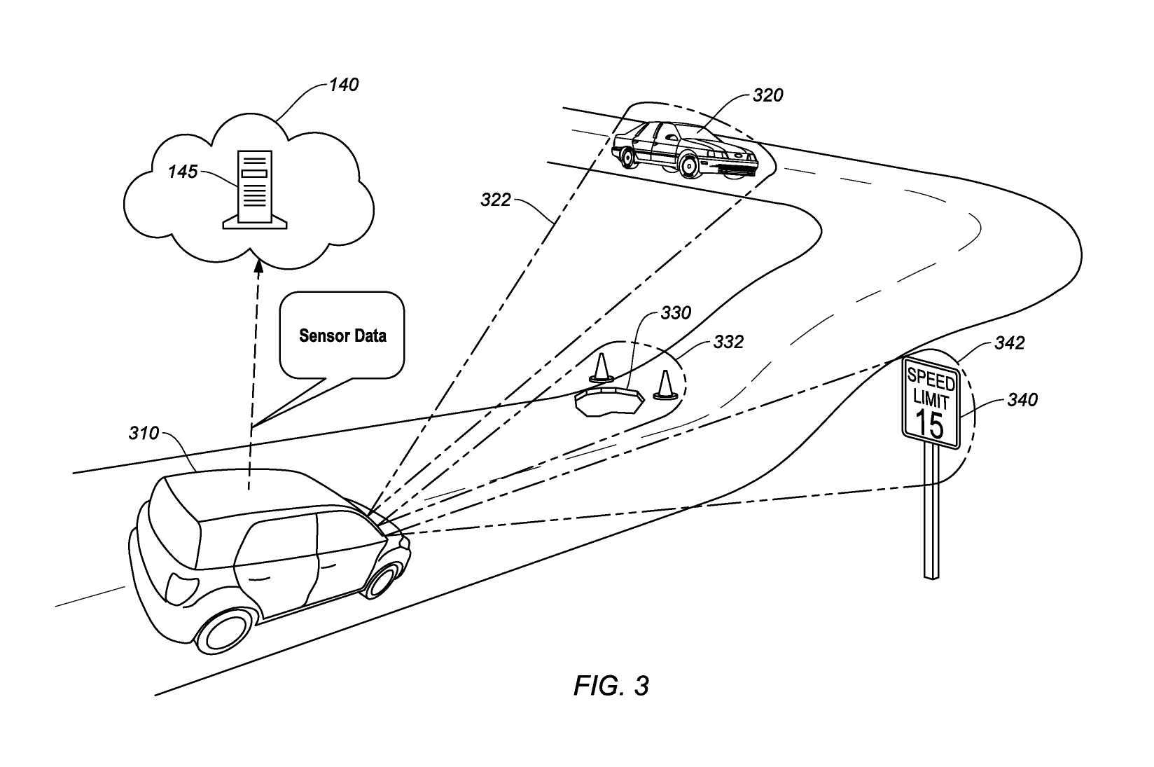

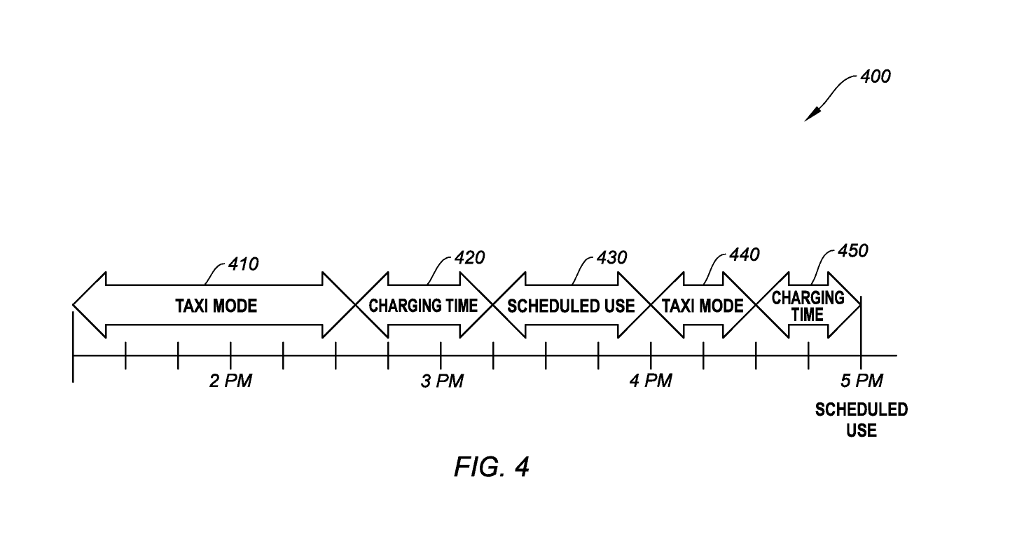

In some implementations, the EV may be used like a taxi service. Some embodiments may manage EV use such that the EV is returned to the charging station with enough time to charge to a threshold charge value before the next user (e.g., owner) is scheduled to use it (e.g., based on next user's calendar data), as shown and discussed with respect to FIG. 4. In some cases, driverless ADAS-equipped vehicles may be used to autonomously drive over a certain area to perform sensor-based tasks (e.g., surveying for map updates, etc.), as shown in FIG. 3.

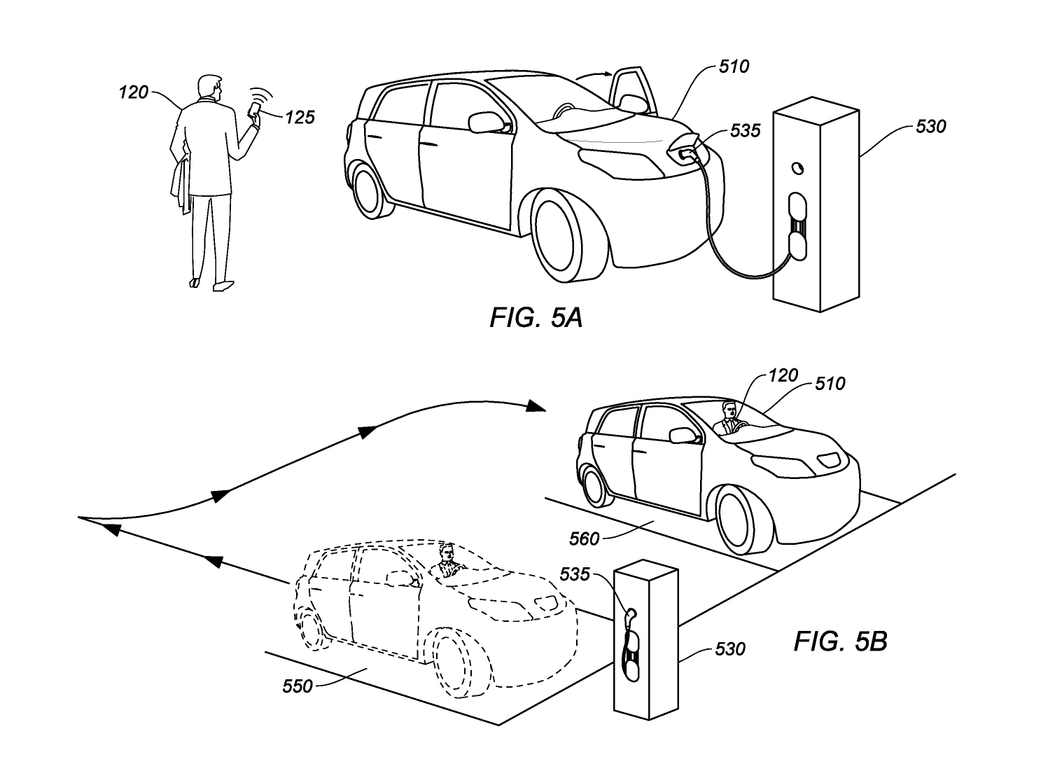

Certain embodiments allow the removal of an EV from a charging station based on a charge status of an energy storage device (e.g., battery) to make the charging station available to another EV. Removal may be manual (e.g., by the user) or automatic, e.g., in advanced driver assistance system (ADAS)-equipped vehicles. One example is shown and described with respect to FIGS. 5A-5B.

A request can be made by an individual (“user”), a server (e.g., managing charging operations over a number of charging stations), or the like. The request can be received directly from a user or local entity (e.g., via Bluetooth®, ZigBee, infra-red, etc.) or a remote entity (e.g., a server on the Cloud) via Wi-Fi, cellular network, any satellite-based network, or the like. One of ordinary skill in the art would understand the many variations, modifications, and alternative embodiments thereof.

Although the following embodiments describe the use of EVs, it should be understood that the concepts described herein can apply to other types of vehicles as well, such as plug-in hybrids, or any other type of vehicle that can utilize a charging station or equivalent thereof.

FIG. 1 shows aspects of providing a user 120 access to EV resources, according to certain embodiments. EV 110 is electrically coupled to charging station 130. EV 110 includes an energy storage device (e.g., one or more batteries) having a charge status 111 indicating that the energy storage device is fully charged. EV 110 can have a number of resources including one or more processor(s) 112, sensor(s) 114, driving control 116, and charging control 118. Sensors 114 can include image sensors (e.g., video cameras, ultrasonic, LIDAR, RADAR, etc.), audio sensors (e.g., microphones), temperature sensors (e.g., thermometers), and the like, which may be internally (e.g., within the cabin of EV 110) or externally (e.g., on outside of EV 110) mounted.

Referring to FIG. 1, user 120 sends request 190 via mobile computing device 125 to access sensor data from EV 110. Mobile computing device 125 can be a smart phone, wearable (e.g., smart watch, smart glasses), laptop computer, tablet computer, or other suitable computing device (e.g., mobile or not-mobile). Request 190 can be routed to server computer(s) 145 in the Cloud 140 and relayed 192 to EV 110. EV 110 can then generate and send a response message 194, including both image data and temperature data from sensor(s) 114, to server 145, which can relay 196 the response message to user 120.

In some embodiments, different methods and paths of communication can be used. For example, user 120 can communicate directly (e.g., via Bluetooth®, ZigBee, etc.) or indirectly via an intermediary (e.g., server 145) using any appropriate local or long-distance (e.g., Wi-Fi, cellular, satellite-based, etc.) communication protocol.

FIG. 2 shows aspects of pooling EV resources across a fleet of vehicles, according to certain embodiments. User 120 requests a task 250 from server 145 located in Cloud 140. Server 145 can pool resources from a number of EVs to carry out requested task 250. For example, server 145 accesses processors from EV 210, EV 220, EV 230, and EV 240 (via requests 212, 222, 232, 242, respectively), where each EV can perform computations corresponding to requested task 250. Each EV 210-240 can return a result (214, 224, 234, 244, respectively) to server 145, which can compile (e.g., aggregate, combine, etc.) and send a result (260) to user 120. Thus, EVs 210-240 can provide distributed computing resources, sensor data, and the like, when they may otherwise be sitting idle on a charging station.

Some examples of bulk processing in a distributed computing arrangement involving multiple vehicles (e.g., in response to a request for resources) can include video encoding of raw data, solving complex algorithms or portions thereof for complex equations, graphics processing, audio processing, scientific data processing (e.g., data dumps from imaging satellites, big data analysis, etc.), biomedical applications (DNA data, gene data, etc.), climatology (e.g., weather data, weather prognostication, etc.), applications in astronomy (e.g., running astrophysics-based models using radiation data, image data, and celestial body movement data), or the like. In some cases, certain algorithms may be performed by resources of a single vehicle or multiple vehicles. Certain tasks may begin by utilizing resources on one set of vehicles, but may be rerouted to another set of vehicles during use. This may occur as different vehicles (and their corresponding resources) become accessible (e.g., vehicles coupled to a charging station and charged to a charge threshold) or leave the pool of available resources (e.g., the vehicle is decoupled from the charging station and is in use by the owner). One of ordinary skill in the art would understand the many variations, modifications, and alternative embodiments thereof.

In some embodiments, the requested task can be unrelated to any specific vehicle. For example, the request can be to perform a computation or to obtain sensor data corresponding to a given location (e.g., temperature data at a particular zip code, area code, or other location or continuous or discontinuous area). Server 145 can scan available resources that are available at the given location and determine which vehicles are suitable for access. In some embodiments, a suitable vehicle can include an EV that is coupled to a charging station with an energy storage device having a charge status of at least a threshold charge value (e.g., 90% fully charged). Any suitable threshold value can be used. Thus, certain requested tasks may require resources (e.g., processor access and sensor access), but the request can be unrelated and may not specify any particular vehicle. In some cases, certain requests can involve distributed computing scenarios including both vehicle and non-vehicle resources (e.g., non-vehicle based server farms, home theater/gaming systems, etc.). One of ordinary skill in the art would understand the many variations, modifications, and alternative embodiments thereof.

In certain embodiments, the EVs may not necessarily be local to one another. For example, EVs from far reaching locations can be accessed for any processing or sensor related tasks. Furthermore, communication protocols between multiple EVs and server 145 (or direct communication with user 120) can differ. For example, some EVs may communication with server 145 via Wi-Fi, while others may use a cellular network. Alternatively or additionally, data can be sent over the charging cable. One of ordinary skill in the art would understand the many variations, modifications, and alternative embodiments thereof.

FIG. 3 shows aspects of using EV sensor resources, according to certain embodiments. EV 310 is shown as an ADAS-equipped vehicle that is autonomously surveying an area and providing high-definition map data using various image sensors including traffic data (e.g., via image 322 of vehicle 320), updated road condition data (e.g., via image 332 of construction work 330), and road sign data (e.g., via image 342 of sign 340). The collected data can be stored locally (e.g., on EV 310) or remotely (e.g., on server 145 in the Cloud 140).

FIG. 4 shows aspects of coordinating usage of EV resources, according to certain embodiments. In addition to EV resources, some embodiments may allow the use of an EV for driving during periods of non-use. In FIG. 4, a user is scheduled to use an EV from 3:15 PM to 4 PM and again after 5 PM, leaving periods of non-use spanning from 1 PM to 3:15 PM and 4 PM to 5 PM.

In some embodiments, the user (e.g., owner) may wish to have a particular charge status for the EVs energy storage device. For example, the user may wish to have threshold charge of least 90% charge on the energy storage device. Any suitable charge threshold value can be used. As such, a requisite amount of time should be allotted to ensure that the EV is charged to the expected charge value by the following period of scheduled use (e.g., period 430, 450). Periods 420 and 450 may define an approximated amount of time that the energy storage device can be charged to the threshold value. Thus, the EV should be coupled to a charging station during periods 420 and/or 450, or portions thereof. Periods 410 and 440 may define a period of use that another user can use the EV for any suitable purpose, including driving (“taxi mode”), sensor access, taxi and sensor access, or the like.

In some embodiments, usage during “taxi mode” may be limited in certain ways. For example, travel may be limited to a certain radius from the charging station based on an approximated travel time from the farthest calculated point on the radius to the charging station. The radius can be defined by a linear distance from the charging station, a travel time from a number of locations (e.g., 30 minutes on at a location on a highway versus 15 minutes at a location in a high-density residential area), or other suitable definition. Some limitations may be set based on charging station availability in certain regions to prevent the EV from running out of charge in an area with no charging capabilities. In some embodiments, an owner (or person with authority over the vehicle) can set limits on who may use the vehicle. For example, the “taxi mode” may be limited to company personnel, family, friends, or any group or subgroup of potential users. One of ordinary skill in the art would understand the many variations, modifications, and alternative embodiments thereof.

In some embodiments, the various periods 410, 420, 440, 450 may be modified based on a number of factors. For example, charge periods can be modified by calculations of an expected charge status of the energy storage device after the user is scheduled to finish using the resources and calculations of an expected completion time to charge the energy storage device to a threshold value after the user is finished using the EV. The time to charge can be based on the expected charge status of the energy storage device after the user is finished using the EV, and an expected charging rate of the energy storage device on the charging station. The charging rate of charging stations may vary between brands, types (e.g., charging station, super-charging station, etc.), and system settings, as would be understood by one of ordinary skill in the art.

In some implementations, the “taxi mode” can be an autonomous mode with no driver (e.g., in ADAS-equipped vehicles). The autonomous taxi mode can be used to collect sensor data (e.g., see FIG. 3) or, in some cases, in can be used testing purposes. For instance, beta development software may be validated during autonomous drives. Beta software modules may include software related to chassis, engine, sensors, perception, planning, or control related to full functionalities of vehicle and autonomous driving that may be tested during periods of non-use. One of ordinary skill in the art would understand the many variations, modifications, and alternative embodiments thereof.

FIG. 5A shows aspects of moving an EV after reaching a threshold charge, according to certain embodiments. EV 510 is coupled to charging station 530 via charging cable 535 with its energy storage device (not shown) charged to a threshold value (e.g., 100%) and sitting idle. User 120 wants to utilize the charger for his own EV (since EV 510 is fully charged) and requests access via mobile computing device 125

In FIG. 5B, access is granted and user 120 decouples EV 510 from charging station 530 and move EV 510 from location 550 to location 560. In some embodiments, user 120 can be local to EV 510 using a short range communications protocol (e.g., Bluetooth, ZigBee, etc.), long range communications protocol (e.g., Wi-Fi, Cellular, etc.), charging cable 535 (e.g., through a charging station user interface), or other suitable communications protocol, as would be understood by one of ordinary skill in the art. In some embodiments, moving fully charged EV 510 (or charged beyond a threshold value) can be an automated process. For example, ADAS-equipped vehicles may automatically move to an unused parking location to make charging station 530 available for another user. Similarly, a second EV may automatically park in location 550 and auto-couple to charging station 530. Alternatively or additionally, the charging station itself may auto-couple and decouple from the EVs.

In certain embodiments, a server, distributed computing entity, or the like, can control charging operations for one or more charging stations and coordinate vehicle automatic charging and removal of ADAS-equipped vehicles and/or contacting vehicle owners/operators for a scheduled removal of their vehicle from a charging station when a charge threshold is met (e.g., 90% charge). In some cases, there may be a queue associated with one or more charging stations. Accounts and billing operations can be associated with charging based on any suitable metric (e.g., amount of energy stored, time spend on the charging device, frequency of use, etc.). Financial penalties may incentivize efficient use of a charging station. For example, time can be billed for each minute a fully charged EV remains coupled to a charging station. In some aspects, the queue can be based on a proximity of a vehicle to the charging device, an urgency level of the need for a charge (e.g., EV with a very low charge value, a guest VIP at a company needs a charge, etc.), a time of arrival (e.g., FIFO), or the like.

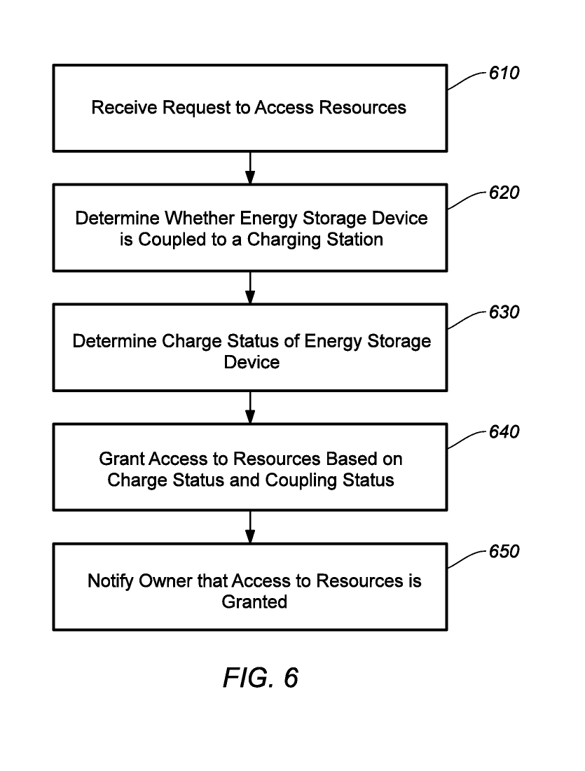

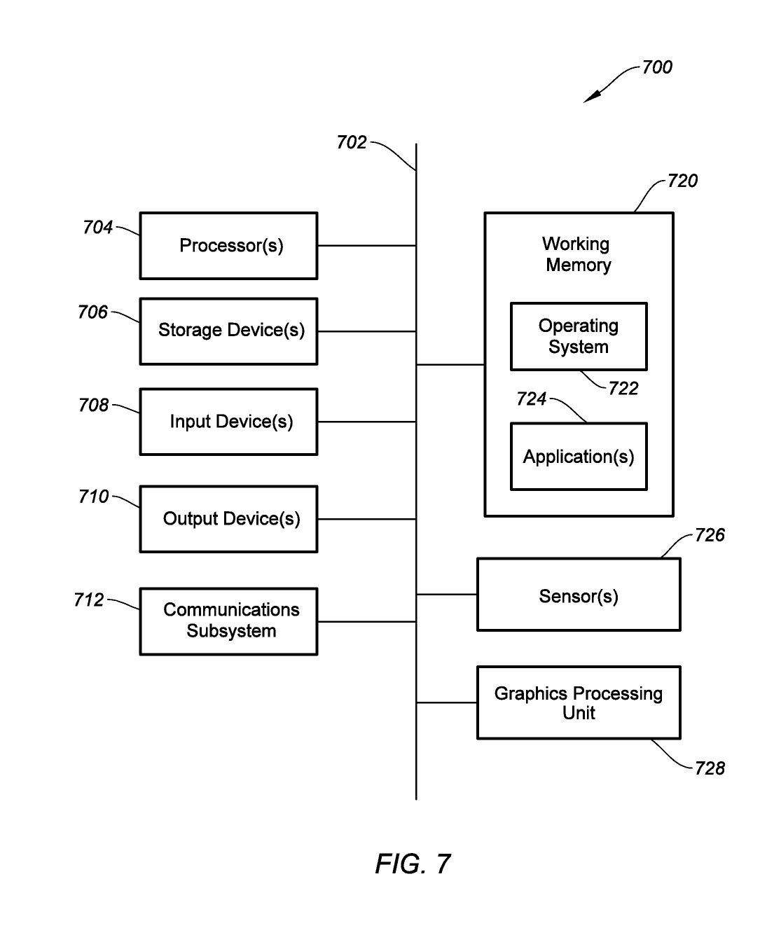

FIG. 6 is a simplified flow chart showing a method 600 for an efficient use of resources of a charged vehicle, according to certain embodiments. Method 600 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 600 can be performed by processor(s) 704 of FIG. 7, or other suitable computing device.

At step 610, method 600 can include receiving one or more requests for access to resources, according to certain embodiments. The request(s) can be from a user, from a server, from internal logic (e.g., automated or scheduled requests from the vehicle or charging station), or the like. For example, a user may wish to access a charging station if the vehicle currently coupled to the charging station is charged to a threshold value (e.g., see FIG. 5A), a server may access one or more vehicles to perform certain computational tasks (e.g., see FIG. 2), a charging station (or managing operative entity controlling the charging station) may automatically request access to a vehicle when charging is complete (e.g., charged to a threshold charge value) to take steps to relocate a charged vehicle to make charging resources available for other vehicles (e.g., see FIG. 5B). Requests can be made for immediate access or scheduled access for use at a later time. One of ordinary skill in the art would understand the many variations, modifications, and alternative embodiments thereof.

In some embodiments, resources can include vehicle resources such as processors, sensors, driving control, and charging control (e.g., charge coupling control, charge value threshold control, etc.), as discussed above with respect to FIGS. 1-3. Sensors can include image sensors (e.g., video cameras, ultrasonic, LIDAR, RADAR, etc.), audio sensors (e.g., microphones), temperature sensors (e.g., thermometers), and the like, which may be internally (e.g., within the cabin of EV 110) or externally (e.g., on outside of EV 110) mounted. By way of example, EV processor control can include performing computational tasks using one or more EV processors. EV sensor control can include controlling and accessing at least one of an image sensor or corresponding image sensor data of the image sensor, an audio sensor or corresponding audio sensor data of the audio sensor, an environmental sensor or corresponding environmental sensor data of the environmental sensor, or the like. In some cases, EV sensor access can include controlling one or more of the EV sensors to generate at least one of high-definition (HD) mapping data, local weather data, or the like. Granting user access to EV automotive control may include providing full driving privileges of the EV to the user, or in some cases, limited driving privileges of the EV to the user including moving the EV from the charging station to a different approved location. EV coupling control may include granting user access to disconnect the energy storage device from the charging station. One of ordinary skill in the art would understand the many variations, modifications, and alternative embodiments thereof.

At step 620, method 600 can include determining whether an energy storage device that provides power to the EV is electrically coupled to a charging station, according to certain embodiments. The energy storage device can include one or more energy storage devices coupled to the EV.

At step 630, method 600 can include determining a charge status of the energy storage device, according to certain embodiments. The charge status may include to what percentage of charge capacity the energy storage device is charged to (e.g., 10% charge?, 50% charge?, 90% charge?). Alternatively or additionally, a charge status may be related to an amount of time that an EV is coupled to a charging station, even if a particular threshold charge (e.g., 90%) is not met. For example, certain charging stations may limit use to 30 minutes per vehicle, which may be modified based on the number of vehicles in a queue that need charging. A threshold charge or charge value may be any suitable threshold and may be defined several ways, such as a percentage charge, a charge value to complete a certain task (e.g., enough charge to drive to driver's home, to the airport, etc.). One of ordinary skill in the art would understand the many variations, modifications, and alternative embodiments thereof.

At step 640, method 600 can include granting access to the resources based on the determination of whether the EV is coupled to the charging station, and the determination of the charge status of the energy storage device. In some embodiments, method 600 can be limited to vehicles coupled to charging stations to ensure efficient usage and better charging station throughput, however granting access can be determined based solely on the charge status, even if the vehicle is not coupled to a charging station. For instance, an ADAS-equipped vehicle may be used for certain resources during periods of non-use and autonomously charged at a charging station prior to the owner's scheduled use, as further discussed above with respect to FIG. 4.

At step 650, method 600 can include notifying an owner of the EV in response to granting access to the resources. For example, the owner may receive a communication (e.g., via text, SMS, e-mail, etc.) indicating that certain resources in her EV are being used, how they are being used, how long, for what purpose, and the like. In some cases, the owner can monitor use in real-time (or non-continuous monitoring) to track location, energy storage device charge status, and the like. In some embodiments, the owner may communicate with the user (when the vehicle is manually operated) during use of the vehicle with any suitable communications protocol, as would be understood by one of ordinary skill in the art.

It should be appreciated that the specific steps illustrated in FIG. 6 provide a particular method 600 for an efficient use of resources of a charged vehicle, according to certain embodiments. Other sequences of steps may also be performed according to alternative embodiments. For example, alternative embodiments may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. It should be noted that certain figures are referred to as references to specific entities (e.g., user 120, EV 110, etc.) in method 600. It should be understood that any of the concepts discussed throughout this disclosure (e.g., FIGS. 1-5B and 9) can be applied to method 600 or variants thereof. One of ordinary skill in the art would recognize and appreciate many variations, modifications, and alternatives of method 600.

FIG. 7 shows a computer system 700 for providing emergency access to a vehicle, according to certain embodiments. Computer system 700 can be used to implement and/or control any of the computer systems/devices (e.g., sensors, communication systems, access grant/denial, etc.) described above with respect to FIGS. 1-8. As shown in FIG. 7, computer system 700 can include one or more processor(s) 704 to communicate with a number of peripheral devices via a bus subsystem 702. These peripheral devices can include storage devices 706 (including long term storage), user input device(s) 708 (e.g. image-based sensors), user output device(s) 710 (e.g., video display to alert user to POI), communications subsystem 712, graphics processing unit 728, sensors 726, and working memory 720. System blocks may be excluded or some may be added, as would be understood by one of ordinary skill in the art. Computer system 700 can reside in a vehicle, server, facility (e.g., charging station network), or a combination thereof, as would be understood by one of ordinary skill in the art.

In certain embodiments, processor(s) 704 may include one or more microprocessors (μCs) and may control the operation of computer system 700. Alternatively, processor(s) 704 may include one or more microcontrollers (MCUs), digital signal processors (DSPs), or the like, with supporting hardware and/or firmware (e.g., memory, programmable I/Os, etc.), as would be appreciated by one of ordinary skill in the art. In some embodiments, processor(s) 704 may be configured to control aspects of an efficient use of resources of a charged vehicle, according to certain embodiments (see, e.g., FIGS. 1-5B), receiving, processing, and responding to requests for resources, and other processes described herein, as would be understood by one of ordinary skill in the art.

In some embodiments, a graphics processing unit (GPU) 728 can operate independently or in conjunction with processor(s) 704 to control one or more output devices 710. For example, output devices 710 may include one or more displays in a vehicle. GPU 728 and/or processor(s) 704 may control graphics, user interface (UI) characteristics, or other display-based functions, as would be appreciated by one of ordinary skill in the art. For instance, GPU 728 may control a UI for user 120 to enter a request for resources as discussed above with respect to FIGS. 1-5B.

In some examples, internal bus subsystem 702 can provide a mechanism for letting the various components and subsystems of computer system 700 communicate with each other as intended. Although internal bus subsystem 702 is shown schematically as a single bus, alternative embodiments of the bus subsystem can utilize multiple buses. Additionally, communications subsystem 712 can serve as an interface for communicating data between computer system 700 and other computer systems or networks (e.g., in the cloud). Embodiments of communications subsystem 712 can include wired interfaces (e.g., Ethernet, CAN, RS232, RS485, etc.) or wireless interfaces (e.g., ZigBee, Wi-Fi, cellular, etc.).

In some cases, input device(s) 708 can include one or more microphones (e.g., to provide audio data to the requesting party), keyboard, pointing devices (e.g., mouse, trackball, touchpad, etc.), a barcode scanner, a touch-screen incorporated into a display, audio input devices (e.g., voice recognition systems, etc.), Human Machine Interfaces (HMI) and other types of input devices. In general, the use of the term “input device” is intended to include all possible types of devices and mechanisms for inputting information into computer system 700. Additionally, user interface output devices 710 can include a display subsystem or non-visual displays such as audio output devices, etc. The display subsystem can be any known type of display device. In general, the use of the term “output device” is intended to include all possible types of devices and mechanisms for outputting information from computer system 700.

Storage devices 706 can include memory subsystems and file/disk storage subsystems (not shown), which can be non-transitory computer-readable storage media that can store program code and/or data that provide the functionality of embodiments of the present disclosure (e.g., method 600). In some embodiments, storage devices 706 can include a number of memories including main random access memory (RAM) for storage of instructions and data during program execution and read-only memory (ROM) in which fixed instructions may be stored. Storage devices 706 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

Computer system 700 can also include software elements, shown as being currently located within working memory 720, including an operating system 722, device drivers, executable libraries, and/or other code, such as one or more application programs 724, which may comprise computer programs provided by various implementations, and/or may be designed to implement methods, and/or configure systems, provided by other implementations, as described herein. Merely by way of example, one or more procedures described with respect to method 600 discussed above can be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by computer system 700 and/or might take the form of source and/or installable code, which, upon compilation and/or installation on computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of computer system 700 may be omitted or may be implemented separate from the illustrated system. For example, processor(s) 704 and/or other elements may be implemented separate from input device(s) 708. In one implementation, the processor may be configured to receive images from one or more image-based sensors (e.g., video cameras).

Some implementations may employ a computer system (such as computer system 700) to perform methods in accordance with the disclosure. For example, some or all of the procedures of method 600 may be performed by computer system 700 in response to processor(s) 704 executing one or more sequences of one or more instructions (which might be incorporated into operating system 722 and/or other code, such as an application program 724) contained in the working memory 720. Such instructions may be read into working memory 720 from another computer-readable medium, such as one or more of storage device(s) 706. Merely by way of example, execution of the sequences of instructions contained in working memory 720 might cause processor(s) 704 to perform one or more procedures of the methods described herein.

The terms “machine-readable medium” and “computer-readable medium,” as used herein, refer to any medium that participates in providing data that causes a machine to operate in a specific fashion. In some implementations implemented using computer system 700, various computer-readable media might be involved in providing instructions/code to processor(s) 704 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as working memory 720. Transmission media include, without limitation, coaxial cables, copper wire, and fiber optics, including the wires that comprise bus subsystem 702, as well as the various components of communications subsystem 712 (and/or the media by which communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 700. These signals, which might be in the form of electromagnetic signals, acoustic signals, optical signals and/or the like, are all examples of carrier waves on which instructions can be encoded, in accordance with various implementations of the invention.

Computer system 700 might also include a communications subsystem 712, which can include without limitation, a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. Communications subsystem 712 may permit data to be exchanged with a network, other computer systems, and/or any other devices described herein. In many implementations, computer system 700 can further comprise a non-transitory working memory 720, which can include a RAM or ROM device, as described above.

In some embodiments, sensor(s) 726 can include any type of image based sensor or video system including, but not limited to, digital camera systems, IR sensors, LIDAR systems, audio-based systems (e.g., ultrasonic, sonar, etc.), or the like. For example, sensors(s) 726 can include the image-based sensors discussed above with respect to FIGS. 1-3. Sensor(s) 726 can further include audio sensors (e.g., microphones), touch-based sensors (e.g., touch sensitive surface 615), or the like. Sensor(s) 726 can be subsumed (be a part of) input device(s) 708 and output devices (710). Thus, sensor(s) 726 and/or input device(s) 708/output device(s) 710 can include and or control all aspects of input, output, sensing, and the like, as described above with respect to FIGS. 1-6.

Many of the embodiments described herein include processing requests for accessing resources on one or more vehicles. Aspects of some or all activities associated with access to resources can be performed by processor(s) 704, by additional blocks (not shown) with logic to control aspects of access, resource control and data routing, or by combinations thereof. In some embodiments, some or all of the functions associated with requests, access, and control may be performed offsite (i.e., not by the vehicle). For instance, decisions to access to resources may be made in a server in the Cloud and the vehicle can merely either grant or deny access based on the determination made by a separate entity. One of ordinary skill in the art would understand the many variations, modifications, and alternative embodiments thereof.

It should be appreciated that computer system 700 is illustrative and not intended to limit embodiments of the present disclosure. Many other configurations having more or fewer components than computer system 700 are possible. Further, computer system 700 may be combined with, subsumed by in part or in whole, or otherwise used in conjunction with computer system 700, as would be understood by one of ordinary skill in the art with the benefit of this disclosure.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof. Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

What is claimed is:

1. A computer-implemented method for operating an electric vehicle (EV), the method comprising:
receiving a request for access to resources;
determining whether an energy storage device that provides power to the EV is electrically coupled to a charging station;
determining a charge status of the energy storage device; and
granting access to the resources based on:
the determination of whether the EV is coupled to the charging station; and
the determination of the charge status of the energy storage device.

2. The computer-implemented method of claim 1 further comprising:
determining that the request is for a user to have the access to the resources;
determining whether the user is one of a set of approved users of the EV; and
determining whether one of the set of approved users is currently using the EV,
wherein granting access to the resources is further based on:
the determination that the user is not one of a set of approved users of the EV; and
the determination that one of the set of approved users is not currently using the EV.

3. The computer-implemented method of claim 2 further comprising:
determining when one of the set of approved users is scheduled to be using the EV;
calculating an expected charge status of the energy storage device after the user is scheduled to finish using the resources; and
calculating an expected completion time to charge the energy storage device to a threshold value after the user is finished using the resources based on:
the expected charge status of the energy storage device after the user is finished using the resources; and
an expected charging rate of the energy storage device on the charging station,
wherein granting the user access to the resources is further based on whether an expected completion time to charge the energy storage device to a threshold value occurs before the one of the set of approved users is scheduled to be using the EV.

4. The computer-implemented method of claim 1 wherein the resources include at least one of:
EV processor access;
EV sensor access;
EV automotive control; or
EV coupling control with the charging station.

5. The computer-implemented method of claim 4 wherein EV processor access includes performing computational tasks using one or more EV processors.

6. The computer-implemented method of claim 4 wherein EV sensor access includes controlling and accessing at least one of:
an image sensor or corresponding image sensor data of the image sensor;
an audio sensor or corresponding audio sensor data of the audio sensor; or
an environmental sensor or corresponding environmental sensor data of the environmental sensor.

7. The computer-implemented method of claim 6 wherein the EV sensor access includes controlling one or more of the EV sensors to generate at least one of high-definition (HD) mapping data or local weather data.

8. The computer-implemented method of claim 4 wherein granting access to EV automotive control includes providing full driving privileges of the EV to a user.

9. The computer-implemented method of claim 4 wherein granting access to EV automotive control includes providing limited driving privileges of the EV to a user including moving the EV from the charging station to a different approved location.

10. The computer-implemented method of claim 4 wherein EV coupling control includes granting user access to disconnect the energy storage device from the charging station.

11. The computer-implemented method of claim 4 further comprising:
notifying an owner of the EV in response to granting access to the resources.

12. A computer-implemented method for operating an electric vehicle (EV), the method comprising:
receiving a request for a task unrelated to the EV;
determining whether an energy storage device that provides power to the EV is electrically coupled to a charging station;
determining a charge status of the energy storage device; and
fulfilling the request for the task by accessing computer or sensor resources on board the EV based on:
the determination of whether the EV is coupled to the charging station; and
the determination of the charge status of the energy storage device.

13. The computer-implemented method of claim 12 wherein fulfilling the request for the task is further based on determining whether one of a set of approved users of the EV is currently using the EV.

14. The computer-implemented method of claim 12 wherein the computer resources on board the EV includes one or more EV processors.

15. The computer-implemented method of claim 12 wherein the sensor resources on board the EV includes at least one of:
an image sensor or corresponding image sensor data;
an audio sensor or corresponding audio sensor data; or
an environmental sensor or corresponding environmental sensor data.

16. The computer-implemented method of claim 12 further comprising:
notifying an owner of the EV in response to the accessing computer or sensor resources on board the EV.

17. A system for operating an electric vehicle (EV) comprising:
one or more processors; and
one or more non-transitory computer-readable storage mediums containing instructions configured to cause the one or more processors to perform operations including:
receiving a request for access to resources;
determining whether an energy storage device that provides power to the EV is electrically coupled to a charging station;
determining a charge status of the energy storage device; and
granting access to the resources based on:
the determination of whether the EV is coupled to the charging station; and
the determination of the charge status of the energy storage device.

18. The system of claim 17 wherein the instructions are further configured to cause the one or more processors to perform operations including:
determining that the request is for a user to have the access to the resources;
determining whether the user is one of a set of approved users of the EV; and
determining whether one of the set of approved users is currently using the EV,
wherein granting access to the resources is further based on:
the determination that the user is not one of a set of approved users of the EV; and
the determination that one of the set of approved users is not currently using the EV.

19. The system of claim 18 wherein the instructions are further configured to cause the one or more processors to perform operations including:
determining when one of the set of approved users is scheduled to be using the EV;
calculating an expected charge status of the energy storage device after the user is scheduled to finish using the resources; and
calculating an expected completion time to charge the energy storage device to a threshold value after the user is finished using the resources based on:
the expected charge status of the energy storage device after the user is finished using the resources; and
an expected charging rate of the energy storage device on the charging station,
wherein granting the user access to the resources is further based on whether an expected completion time to charge the energy storage device to a threshold value occurs before the one of the set of approved users is scheduled to be using the EV.

20. The system of claim 19 wherein EV coupling control includes granting access to disconnect the energy storage device from the charging station.
